(19) United States
(12) Patent Application Publication
(10) Pub. No.: US 2007/0139514 A1
(43) Pub. Date: Jun. 21, 2007

(54) Television set-top video phone system

(76) Inventor: Robert P. Marley, North Wales, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/311,075

(22) Filed: Dec. 19, 2005

(51) Int. Cl. H04N 7/14

(52) U.S. Cl. 348/14.01

(57) ABSTRACT

A system for initiating, receiving, and storing video telephony calls via a broadband television network. The system provides for the integration of all video telephony functions into the user-friendly platform of a residential set-top box which also provides standard cable television and digital video recorder functions.

### FIELD OF THE INVENTION

This invention relates to the field of video telephony, and in particular to video telephony implemented via a broadband connection provided by a pre-existing cable television infrastructure.

### BACKGROUND OF THE INVENTION

The quest for a practical video telephone for the consumer market has been on going for many decades. Prototype videophones were under development by AT&T Bell Laboratories in the late 1950's, and a Bell System videophone (PicturePhone™) was marketed by AT&T and Western Electric from the early 1960's through the early 1970's. AT&T also marketed a consumer videophone, the VideoPhone 2500™, in 1992. However, these and other early videophones met with limited commercial success due in part to the high cost of the devices (each VideoPhone 2500™ sold for $1500.00 in 1992), and the high cost of utilizing the needed communication channels (21 dollars for a one minute videophone call in 1964). These impediments gave rise to a third barrier to the acceptance of video communication technology—The lack of a significant base of consumers likely to quickly adopt videophones as a means of conducting day-to-day communications. Without the likelihood of this base coming into being, there is little incentive for any one consumer to make a large initial investment in video telephony technology. The wisdom of purchasing an expensive videophone and/or the associated premium telecommunication services isn't readily evident if you can only contact a very limited group of other videophone owners.

More recent videophone offerings have overcome, to a certain extent, the first two hurdles that the earlier videophone products met. Broadband videophones, such as the Packet8™. DSL videophone, Motorola's Ojo™ videophone, and VoIP videophone services such as those offered by Skype™, arguably provide users with acceptable video quality at a cost that many consumers might find attractive. However, wide consumer acceptance of videophones is still not a reality. One reason is the previously mentioned third barrier; there is still a lack of confidence that a significant base of consumers will quickly adopt videophones as a means for conducting day-to-day communications. All present videophone systems require consumers to purchase some additional appliance (i.e., stand-alone videophone), or modify/augment an existing appliance (VoIP, personal computer-based video telephony) in order to enable the service, and then hope that a significant number of other consumers make similar purchases and/or compatible modifications.

It would be advantageous, therefore, to provide video telephony functionality and services to a consumer via an information appliance and telecommunication infrastructure that is preexisting in a large number of residential environments.

### SUMMARY OF THE INVENTION

The aforementioned limitations and drawbacks of previous video telephony systems are overcome in accordance with the principles of this invention by an improved system and method for providing for the incorporation of video telephone functionality into existing cable television set-top box/Digital Video Recorder (“DVR”) technology. This provides a new bundled product package to consumers (digital TV/DVR/videophone) via a familiar, widely employed platform, and an established broadband residential network (cable television), thereby fostering quick adoption and the formation of a significant base of video telephone users. Furthermore, the invention allows for pre-existing DVR features and functions (program record and playback) to be utilized for implementing and supporting video communications.

### BRIEF DESCRIPTION OF THE DRAWINGS

For a complete understanding of the present invention and the advantages thereof, reference is now made to the following description taken in conjunction with the accompanying drawings, wherein:

FIG. 1 is a block diagram of a first preferred embodiment of a video telephony system utilizing the invention;

FIG. 2 is a block diagram depicting the networking of several residential locations via a Multiple System Operator;

FIG. 3 is a block diagram depicting a Multiple System Operator network connection between two residential locations, each employing a preferred embodiment of the invention;

FIG. 4 is a flowchart diagram of the steps for initiating a video telephone call employing a preferred embodiment of a the invention;

FIG. 5 is a flowchart diagram of the steps for accepting a video telephone call in real time employing a preferred embodiment of a the invention;

FIG. 6 is a flowchart diagram of the steps for called party diversion of a video telephone call to a DVR employing a preferred embodiment of a the invention;

FIG. 7 is a flowchart diagram of the steps for refusing to accept a video telephone call employing a preferred embodiment of a the invention; and

FIG. 8 is a flowchart diagram of the steps for the automatic diversion of a video telephone call to a DVR employing a preferred embodiment of the invention.

### DESCRIPTION OF PREFERRED EMBODIMENTS

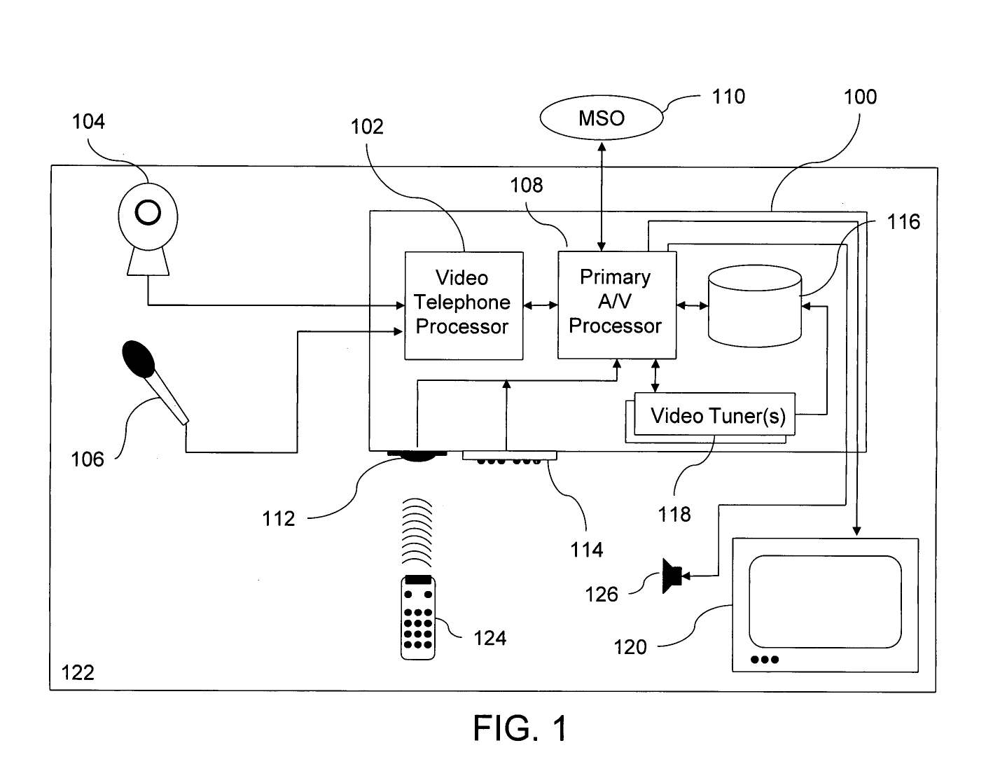

Referring to FIG. 1, in a preferred embodiment the system includes DVR-capable set-top box 100. DVR-capable set-top appliances are well known in the art, and widely employed in residential environments for the viewing and storage of digital video programming. One example of such is the Motorola DCT6208/6412 which employs multiple video tuners thereby enabling a user to view one video program source, while simultaneously recording a second. In this embodiment, additional video processing capabilities, specifically directed to controlling and managing video telephone functions, are provided within video telephone set-top box 100 by video telephone processor (“VTP”) 102. VTP 102 is linked to camera 104, microphone 106, and primary audio/video processor (“PAVP”) 108. PAVP 108 performs the types of audio and video processing typically associated with DVR-capable set-top appliances, including: routing incoming signals to/from a Multiple System Operator (“MSO”) 110, encoding/decoding video and audio, responding to user commands input to remote control 124 and received via remote control receiver 112, responding to user commands received via manual input panel 114, managing the storage and retrieval of video from DVR memory 116, controlling video tuner(s) 118, directing audio and video output to monitor 120 and speaker 126, respectively. It should be understood that PAVP 108 may include multiple sub-processors and related systems, well-known in the art, to perform the listed operations. This is a function of the specific set-top appliance architecture and need not be addressed here.

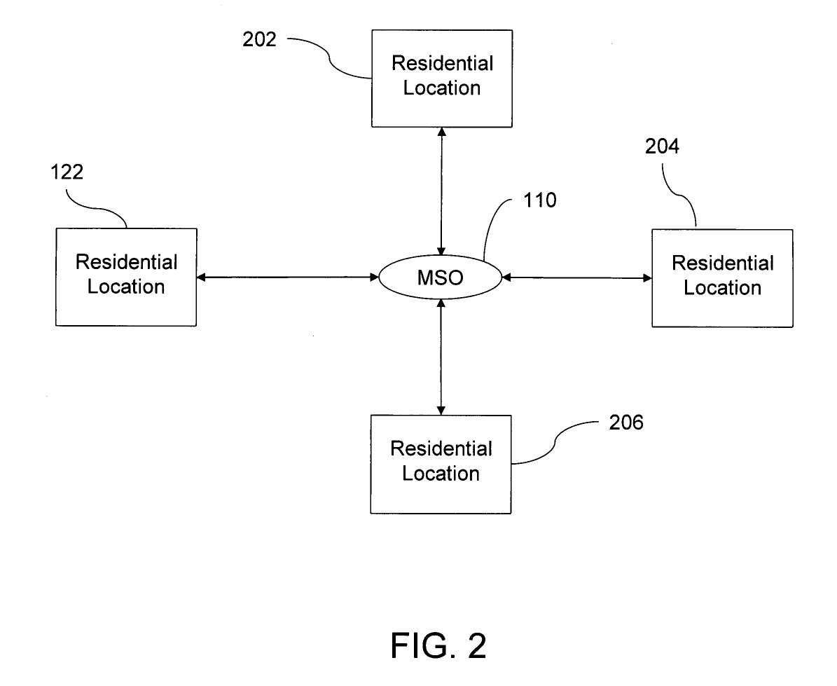

In this embodiment of the invention, camera 104 and microphone 106 are situated in residential location 122 as set-top box 100 and monitor 120, so that the voice and image of an individual viewing monitor 120 and operating set-top box 100 could be captured by microphone 106 and camera 104, respectively. As shown in FIG. 2, residential location 122 is networked via the cable television infrastructure of MSO 110 to additional residential locations 202, 204, and 206. For purposes of this description, each of these residential locations is assumed to have a video telephone set-top box arrangement similar to that described for residential location 122.

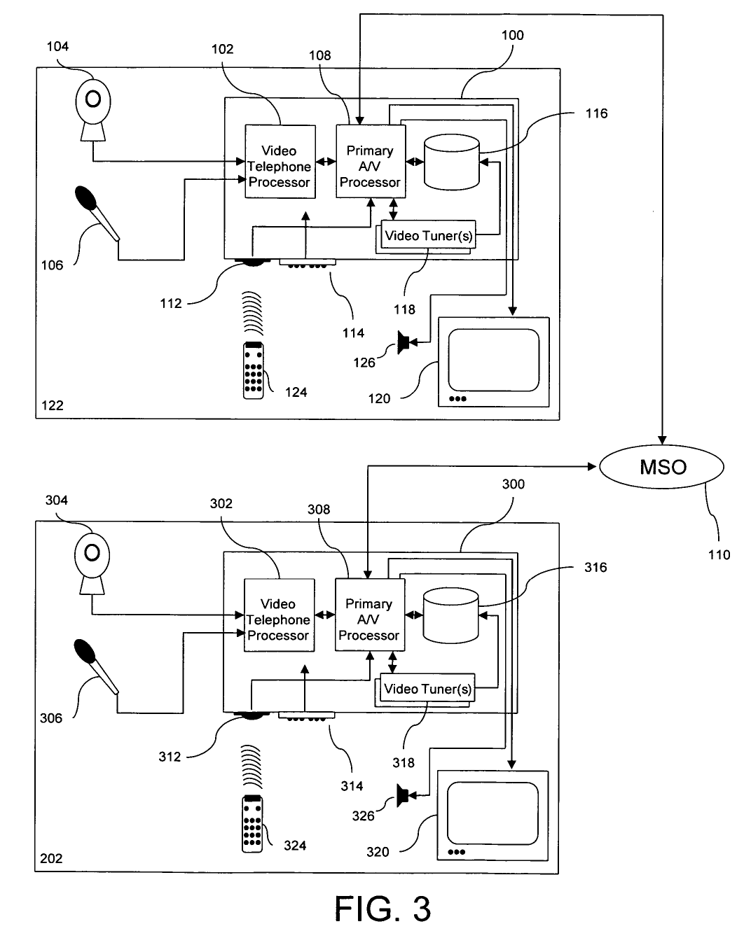

A more detailed depiction of residential location 122 networked via MSO 110 to residential location 202 is shown in FIG. 3. The video telephone set-top box arrangement at residential location 202 includes: video telephone set-top box 300, VTP 302, camera 304, microphone 306, PAVP 308, remote control receiver 312, input panel 314, DVR memory 316, video tuner(s) 318, monitor 320, remote control 324, and speaker 326.

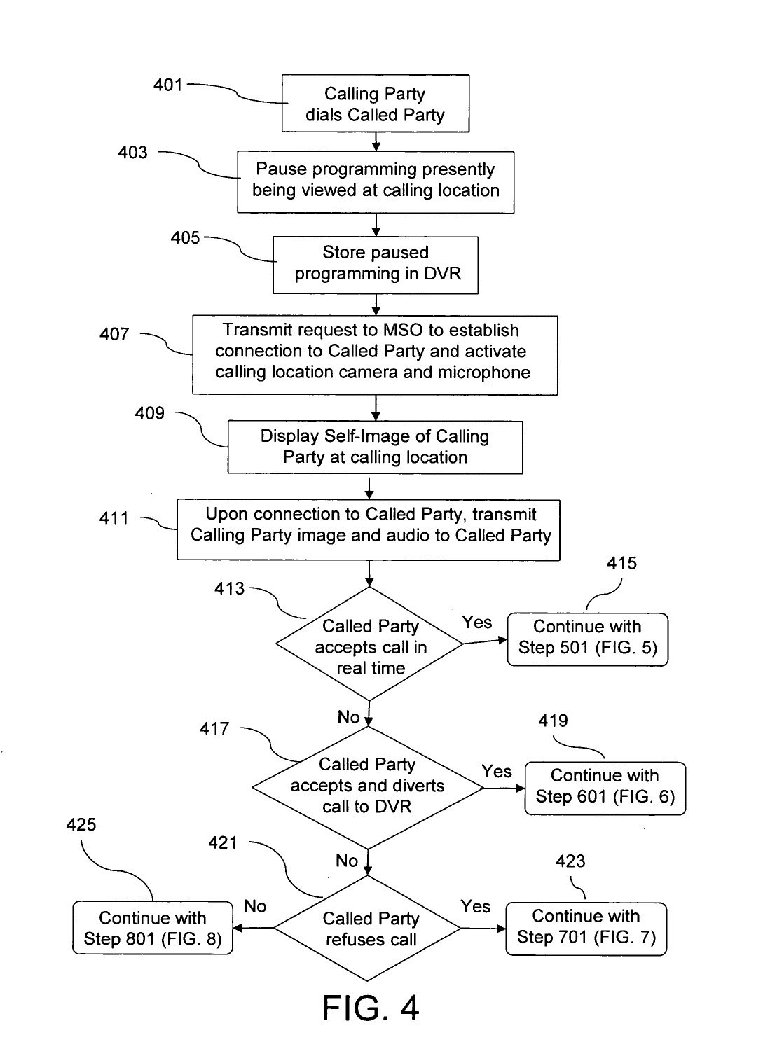

With reference to FIG. 3 and FIG. 4, a calling party situated at residential location 122 would initiate a video call to a called party at residential location 202 by effecting a “dial” command using remote control 124 or manual input panel 114 (401). For example, after actuating a “dial” button, the calling party would then either manually enter the called party's video telephone number, or select the called party from a previously stored video “phone book” retrieved from DVR memory 116 and displayed on at least a portion of monitor 120. The receipt of a “dial” command by PAVP 108 would also initiate the muting and/or pausing of any programming presently being viewed on monitor 120 (403). Any paused programming would be stored in DVR memory 116 for viewing after the termination of the video call being established (405).

Once the proper phone number was entered or recalled, PAVP 108 would cause a request to connect with residential location 202 to be sent to MSO 110 (407). This request could be routed by MSO 110 in a manner not unlike a standard VoIP voice or video that is regularly handled by MSO's today, and a connection would be established with video telephone set-top box 300 at residential location 202. In response to the “dial” command, PAVP 108 would also communicate with VTP 102 to activate camera 104 and microphone 106, and provide for the encoding of the audio from microphone 106 and images from camera 104 to a format compatible with PAVP 108 (407). VTP 102, in conjunction with PAVP 108, would also provide a real time image of camera 104's output on a portion of monitor 120 for viewing by the calling party (409). This type of “self-image” feedback is a feature presently found on commercially available video telephones, letting the calling party see the image being transmitted to the called party.

Upon establishment of a connection to video telephone set-top box 300 the video image and audio from camera 104 and microphone 106 would be transmitted for reception by set-top box 300 (411). PAVP 308 would then generate a caller ID message (a window, a crawler, an overlay) on monitor 320. The called party would then press the appropriate button on remote control 324 or manual input panel 314 to either: 1) accept the call in real-time (413, 415); 2) accept the call but divert it to DVR memory 316 as a video answering machine (417, 419); or 3) refuse the call (421, 423). The fourth option (425) would be the situation where the called party was not at home and/or video telephone set-top box 300 was not in active use when the incoming call arrived. A more detailed discussion of the above options is provided below:

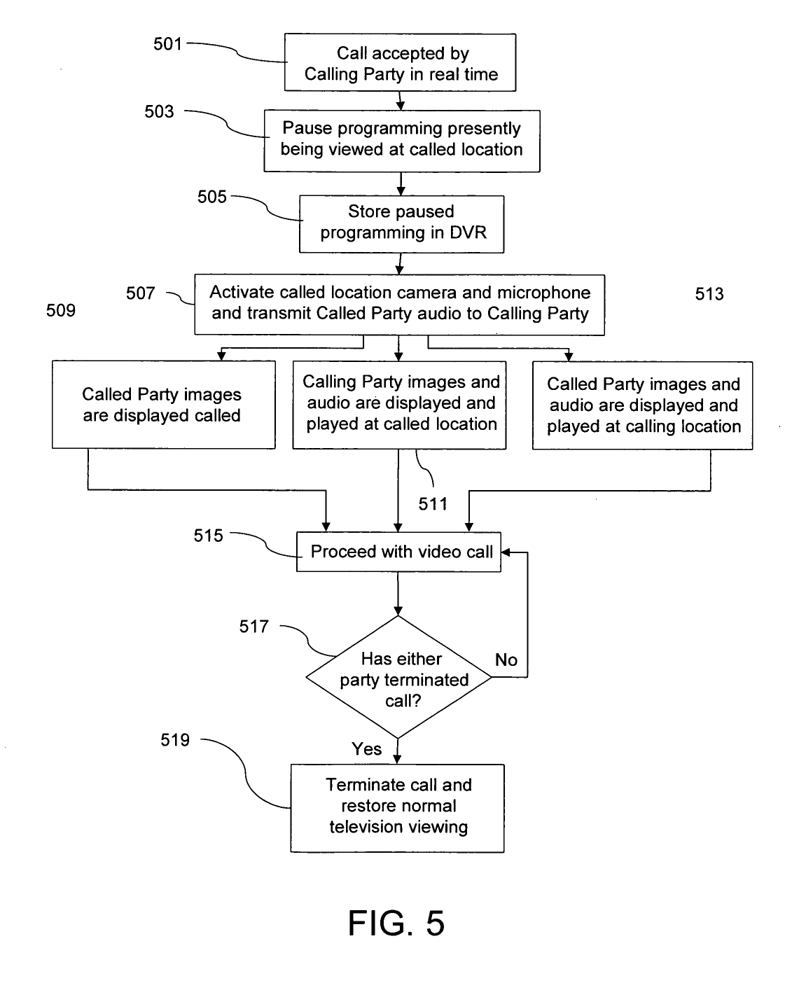

Option 1) As shown in FIG. 5, after calling party initiates (“dials”) a video call, the call placed to residential location 202 is accepted in real-time (501).
Acceptance of the call causes PAVP 308 to mute and/or pause any programming presently being viewed on monitor 320 (503), and store the paused programming in DVR memory 316 for viewing after the termination of the video call (505). VTP 302 activates camera 104 and microphone 106, and in conjunction with PAVP 308, transmits the video image and audio from camera 304 and microphone 306 for reception by set-top box 100 (507), and provides a real time “self-image” of camera 304's output on a portion of monitor 320 for viewing by the called party (509). The received image from residential location 122 is displayed on at least a portion of monitor 320, and audio received from residential location 122 is played on speaker 326 (511). Simultaneously, images received by video telephone set-top box 100 from the called party is displayed at residential location 122 on at least a portion of monitor 320, and audio received from the called party is played on speaker 126 (513). A video phone call is carried out between the two parties in a normal fashion (515). The call could be terminated by either party actuating a button on their remote control 124 or 324, or manual input panel 114 or 314 (517). Upon such termination, the respective PAVPs (108, 308) at the residential locations 122 and 202 restore normal television viewing, thereby allowing the calling and called parties to resume real time program viewing, or recall the paused programming from DVR memory (116, 316) for viewing (519).

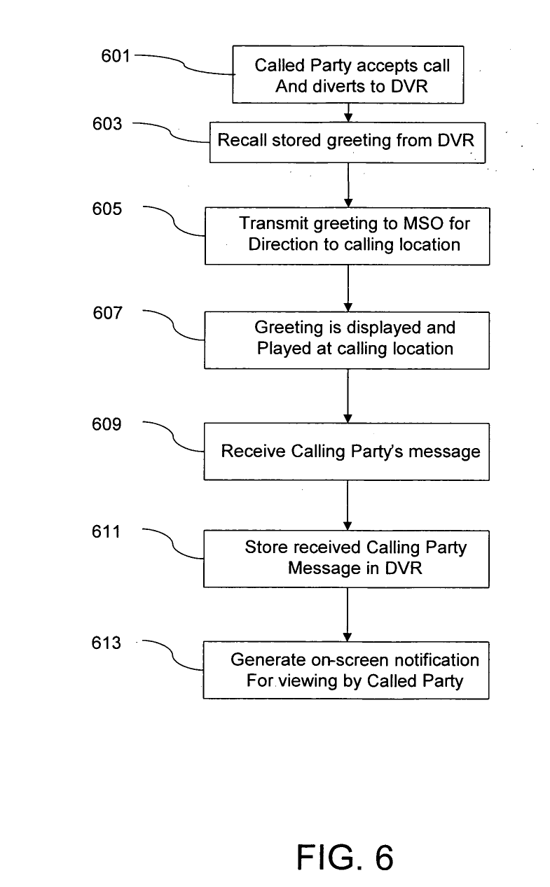

Option 2) As shown in FIG. 6, after calling party initiates (“dials”) a video call, the call placed to residential location 202 is accepted and diverted it to DVR memory 316 (601).
In this case the called party is made aware of the incoming call, but chooses to have the call diverted to DVR memory 316 for storage and later viewing. This diversion could be executed automatically by PAVP 308 after a predetermined number of “rings” or a fixed time period elapses. It could also be executed in response to a called party command received via remote control receiver 312 or manual input panel 314 (i.e., depressing a “divert call” key). In diverting the call, PAVP 308 first recalls a previously stored “greeting” from DVR memory 316 (603) and directs it to video telephone set-top box 100 via the MSO connection (605). The greeting image is then displayed at residential location 122 on at least a portion of monitor 320, and the greeting audio is played on speaker 126 (607). This greeting could be a system greeting informing the calling party that the called party cannot take the call, and requesting they leave a video message following the termination of the greeting. This stored greeting could also be a more personalized message that the called party record and stored in DVR memory 316. In either case, the calling party's message would be received (609), and recorded (along with time and caller ID information) in DVR 316 for later retrieval and viewing by the called party (611). PAVP 308 is also adapted to permit the generation of an on-screen message (a window, a crawler, an overlay) on monitor 320 notifying the called party that a new video message was indeed recorded (613). This on-screen message could include caller ID information and/or a still image sampled from the recorded video message. The called party could retrieve stored messages using an onscreen menu similar to that used to retrieve standard DVR-recorded TV broadcasts.

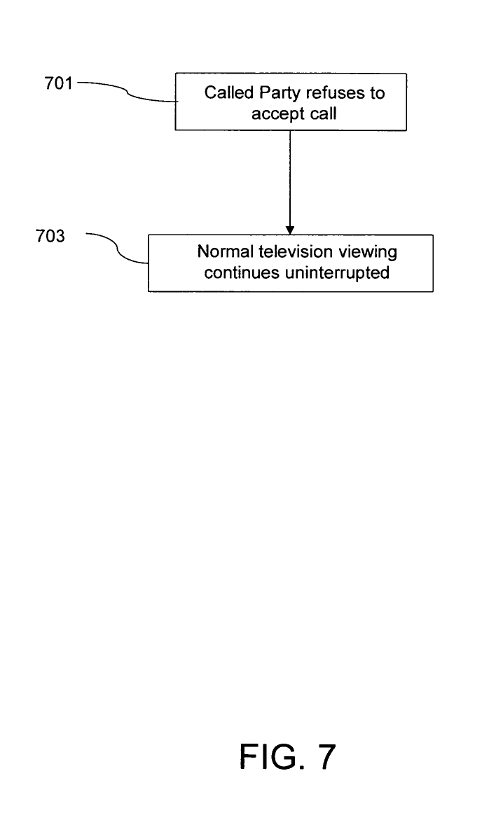

Option 3) FIG. 7 shows the case where the called party refuses to accept the incoming calling party a video call.
Called party at residential location 202 is viewing TV, and is made aware of the incoming call via on-screen message. However, the call is actively dismissed by pressing a button on remote control 324 or manual input panel 314 (701). No video link is established. No option of leaving a message if offered to the calling party. Normal TV viewing continues (703).

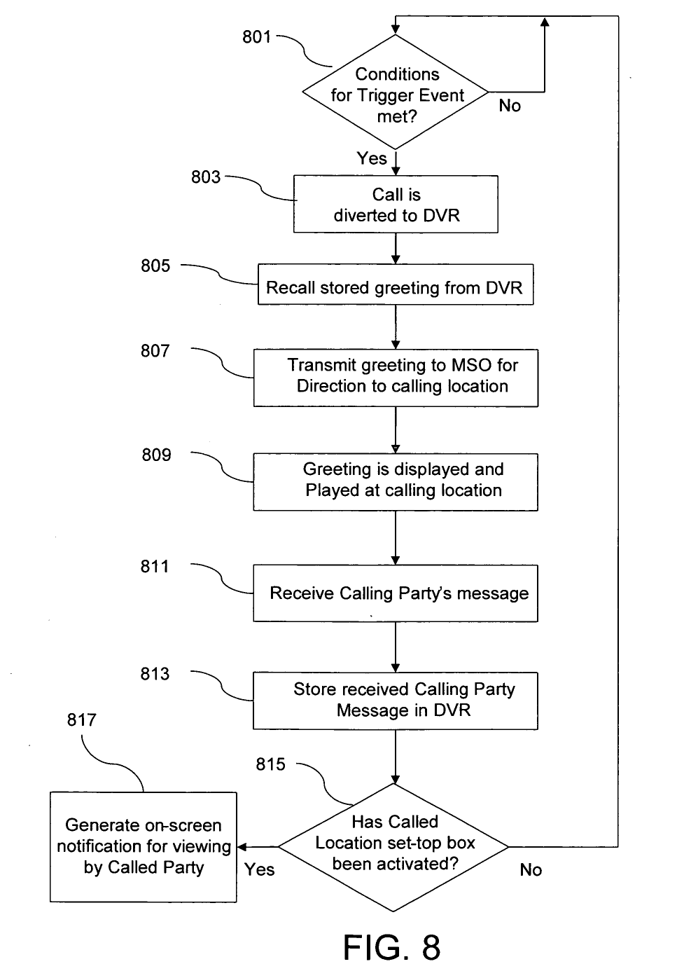

Option 4) FIG. 8 shows the case where the called party at residential location 202 is not at home, and/or video telephone set-top box 300 was not in active use when the incoming call arrives.
After a trigger event (801), such as predetermined number of “rings” or the expiration of a predetermined period of time, diversion of the incoming call to DVR memory 316 is automatically executed by PAVP 308 (803). As in option 2, PAVP 308 first recalls a previously stored “greeting” from DVR memory 316 (805) and directs it to video telephone set-top box 100 via the MSO connection (807). The greeting image is then displayed at residential location 122 on at least a portion of monitor 320, and the greeting audio is played on speaker 126 (809). The calling party's message would then be received (811), and recorded (along with time and caller ID information) in DVR 316 for later retrieval and viewing by the called party (813). The next time video set-top box 300 was activated (815), PAVP 308 would generate an on-screen message on monitor 320 notifying the called party that a new video message was recorded (817). This diversion, although automatic, may still be conditional. It may be undesirable to have every incoming unanswered call stored in DVR memory 316. VTP 302 and/or PAVP 308 could maintain a list of all calling parties from whom video telephone set-top box 300 is authorized to automatically accept and store messages. If the calling party is not on the list, no option to record a message is offered to the calling party (this would be an additional requirement for the above mentioned “trigger event” (801)).

In the described embodiment, the particular means by which the camera and microphone are connected to the video telephone set-top box was not specified. It is understood that these connections could be wire line or wireless, and that either or both the camera and microphone could be implemented in an integrated fashion as components of the video telephone set-top box itself (condenser microphone, wide-angle camera). Furthermore, although the particular described embodiments used the term “video telephone set-top box”, it is well understood in the art that set-top box features and functionality can be integrated into a TV or monitor, so that no separate physical box is needed. The features and functionality disclosed herein may also integrated into a TV and/or monitor in a similar fashion so that there need not be a separate physical set-top box. It should also be understood, that although the particular connection between residential locations described herein involved only one MSO, this invention is also applicable to multiple MSO environments, where video calls are being made from one MSO's network to another MSO's network. Such inter-MSO routing is well known in the art.

Furthermore, although the invention has been described herein by reference to exemplary embodiments thereof, it will be understood that modification and variation to such, without departing from the inventive concepts disclosed, can be made. All such modifications and variations, therefore, are intended to be encompassed within the spirit and scope of the appended claims.

I claim:

1. A television set-top box video telephony system comprising at least a video signal tuner, a digital video recorder, including a memory storage means, a video camera, a microphone, a monitor adapted for viewing video programming, an audio system adapted for reproducing audio associated with said video programming, a user command interface, a bidirectional connection to a broadband television service network system, and a processing means responsive to said user command interface and adapted for controlling the tuning via said video signal tuner, wherein said processing means is further adapted to:
initiate a video telephone call to at least one specified called party;
transmit a request via said broadband television service network system to effect a connection to said at least one specified called party;
display a real time image of video from said video camera on at least a first portion of said monitor;
display on at least a second portion of said monitor a real time image of video received from said called party via said broadband television network; and
reproduce on said audio system a real time audio signal received from said called party via said broadband television network.

2. The television set-top box video telephony system of claim 1, wherein said processing means is further adapted to:
pause and store programming being viewed by said calling party on said monitor, and reproduced on said audio system in response to said calling party input.

3. The television set-top box video telephony system of claim 1, wherein said processing means is further adapted to respond to input received via said user command interface to initiate a video telephone call.

4. The television set-top box video telephony system of claim 1, wherein said user command interface includes at least one handheld remote control device.

5. The television set-top box video telephony system of claim 1, wherein said monitor and said audio system are components of a television.

6. The television set-top box video telephony system of claim 1, wherein said microphone is integral to said television set-top box.

7. The television set-top box video telephony system of claim 1, wherein said camera is integral to said to said television set-top box.

8. The television set-top box video telephony system of claim 1, wherein said microphone is connected to said television set-top box by a wireless link.

9. The television set-top box video telephony system of claim 1, wherein said camera is connected to said television set-top box by a wireless link.

10. The television set-top box video telephony system of claim 1, wherein said processing means is further adapted to transmit a video recalled from said memory storage means to said calling party via said broadband television network system.

11. A television set-top box video telephony system comprising at least a video signal tuner, a digital video recorder, including a memory storage means, a video camera, a microphone, a monitor adapted for viewing video programming, an audio system adapted for reproducing audio associated with said video programming, a user command interface, a bidirectional connection to a broadband television service network system, and a processing means responsive to said user command interface and adapted for controlling the tuning via said video signal tuner, wherein said processing means is further adapted to:
accept a video telephone call from a calling party in response to input received via said user command interface;
display a real time image of video from said video camera on at least a first portion of said monitor;
display on at least a second portion of said monitor a real time image of video received from said calling party via said broadband television network; and
reproduce on said audio system a real time audio signal received from said calling party via said broadband television network.

12. The television set-top box video telephony system of claim 1, wherein said processing means is further adapted to:
pause and store programming being viewed by on said monitor, and reproduced on said audio system in response to said acceptance of a video telephone call.

13. The television set-top box video telephony system of claim 1, wherein said processing means is further adapted to respond to input received via said user command interface to accept a video telephone call.

14. The television set-top box video telephony system of claim 1, wherein said user command interface includes at least one handheld remote control device.

15. The television set-top box video telephony system of claim 1, wherein said monitor and said audio system are components of a television.

16. The television set-top box video telephony system of claim 1, wherein said microphone is integral to said television set-top box.

17. The television set-top box video telephony system of claim 1, wherein said camera is integral to said to said television set-top box.

18. The television set-top box video telephony system of claim 1, wherein said microphone is connected to said television set-top box by a wireless link.

19. The television set-top box video telephony system of claim 1, wherein said camera is connected to said television set-top box by a wireless link.

20. The television set-top box video telephony system of claim 1, wherein said processing means is further adapted to transmit a video message recalled from said memory storage means to said calling party via said broadband television network system.

21. The television set-top box video telephony system of claim 20, wherein said processing means is further adapted to automatically transmit said video message recalled from said memory storage means to said calling party when a predetermined trigger event has been determined to have occurred.

22. The television set-top box video telephony system of claim 20, wherein said processing means is further adapted to store in said memory storage means a video message received from said calling party via said broadband television network system.
